(19) United States
(12) Patent Application Publication
(10) Pub. No.: US 2010/0104712 A1
(43) Pub. Date: Apr. 29, 2010

(54) METHOD OF PRODUCING INTACT PARTICLES CREATING AN APPEARANCE OF CHEESE PARTICULATES IN A SHELF STABLE PASTEURIZED SAUCE

(75) Inventors: Michael Charles BUDD, North Haledon, NJ (US); Richard POYE, Englewood, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/260,190

(22) Filed: Oct. 29, 2008

(51) Int. Cl. A23C 19/097

(52) U.S. Cl. 426/334

(57) ABSTRACT

A method of producing intact particles creating appearance of cheese particulates in a shelf stable pasteurized sauce is provided. A gelling agent is included in an oil-in-water emulsion, which is submerged in an ionic bath, to form particulates having the appearance of cheese but which do not melt when incorporated in a pasteurized sauce.

### FIELD OF INVENTION

The present invention relates to method of producing intact solid particles creating appearance of cheese particulates in a shelf stable pasteurized sauce. In particular, the present invention provides a method of producing intact particles creating the appearance of cheese particulates in a shelf stable pasteurized sauce by preparing an emulsion containing a gelling agent, placing the emulsion in an ionic bath to obtain particles that resemble cheese but are capable of withstanding the pasteurization in the sauce.

### BACKGROUND

There is a consumer need for visible cheese particles in a heat up sauce. The difficulty in producing such particles has been in that cheese tends to melt upon pasterizing the sauce and, while present, is not discretely visible.

While cheese and imitation cheese are well known products, much of the related art focuses on aspects that do not render the present invention predictable to one skilled in the art. For example, the goal in Bot, US Published Patent Application No. 2005/0069619 is a spreadable product. US2007/0154612 published to Kraft aims to retain melting properties of cheese while avoiding agglomeration. U.S. Pat. No. 6,929,814 and US2006/0292280 relate to encapsulation of flavors to protect the flavors from harsh cooking applications.

A method for producing intact solid particles creating an appearance of cheese particulates in a shelf stable pasteurized sauce has not been shown prior to the present invention.

### SUMMARY OF THE INVENTION

To cure the deficiencies discussed above, the present invention provides a method for producing intact particles creating the appearance of cheese particulates in a shelf-stable pasteurized sauce, comprising:

(a) preparing an oil-in-water emulsion comprising a water phase, an oil phase, and an emulsifier; and adding about 2% to about 5% by weight sodium alginate, preferably about 3% by weight, to the water phase of said emulsion;

(b) placing said emulsion in an ionic solution;

thereby producing intact solid particles; wherein said particles have the appearance of cheese and are heat and pH stable so that they maintain the cheese appearance even after pasteurization in the sauce.

“Appearance” as used herein means visual, textural, and mouthfeel consumer association with cheese. In other words, even a particulate that comprises little or no cheese that has the appearance of cheese, as used herein, means would be assumed by the consumer to be and would imitate cheese—e.g. mozarella cheese.

Edible oils that are liquid at ambient temperatures are most suited for emulsions according to the present invention. Preferably, vegetable oils are used. Olive oil is a most preferred oil in the emulsion, for its health aspects and general desirability as a savory sauce ingredient. The emulsification process may further comprise incorporation of air into the emulsion. Preferably, the emulsion is opaque.

A preferred ionic solution contains calcium chloride at about 5% by weight.

“Intact particle” means not completely melted in a pasteurized sauce, so that the particle is still recognizable as a distinct particle, such as a particulate of grated or shredded mozarella cheese for example. Preferably the intact particles are solid. The intact solid particles may take on any shape or size. Most preferably the intact solid particles have the appearance and texture of grated or shredded cheese particulates, e.g. 2-4 mm in thickness or in smallest dimension.

Sauce, as used herein, is a liquid dressing meant to be served with food, including a gravy. In a pasteurized sauce, the intact particles are required to have heat resistance to melting at temperatures of at least about 90° C. (about 195° F.), preferably at least about 100° C. (212° F.). Preferably, the sauce is non-retorted, shelf-stable, and has a pH of about 3.5 to about 4.5, more preferably about 3.8 to about 4.2, and the intact solid particles remain stable at these conditions.

The term “comprising” is used herein in its ordinary meaning and means including, made up of, composed of, consisting and/or consisting essentially of. In other words, the term is defined as not being exhaustive of the steps, components, ingredients, or features to which it refers.

Except in the operating and comparative examples, or where otherwise explicitly indicated, all numbers in this description indicating amounts or ratios of material or conditions of reaction, physical properties of materials and/or use are to be understood as modified by the word “about”.

### DETAILED DESCRIPTION OF THE INVENTION

The present invention is directed to a method for producing intact particles creating the appearance and texture of cheese particulates in a shelf-stable pasteurized sauce, comprising:

(a) preparing an oil-in-water emulsion comprising a water phase, an oil phase, and an emulsifier; and adding about 2% to about 5% by weight sodium alginate, preferably about 3% by weight, to the water phase of said emulsion;

(b) placing said emulsion in an ionic solution;

thereby producing intact solid particles; wherein said particles have the appearance of cheese and are heat and pH stable so that they maintain said cheese appearance even after pasteurization in said sauce.

The particles according to the present invention are a thermally stable gel mimic for a dairy ingredient. A gelled emulsion can take on the form of particulates having the appearance of grated cheese, which can be thermally treated without melting or losing its shape. Unexpectedly, the inventive particulates give consumers the appearance of cheese in sauce, while the content of real cheese in the sauce product prepared by the method of the present invention is optional. Preferably, the real cheese is present in the sauce although it will not be visible due to melting upon pasteurization of the sauce.

Emulsion, as used herein, means a suspension or dispersion of one liquid within a second immiscible liquid and is preferably an oil-in-water emulsion. The emulsion is prepared using conventional emulsification techniques, by mixing a composition containing oil, water, emulsifier, and optional ingredients. Suitable emulsifers have HLB values of 10 to 15. An example of suitable emulsifier is polysorbate 60 (P-60). The emulsification process may further comprise incorporation of air into the emulsion. Preferably, the emulsion is opaque.

Edible oils that are liquid at ambient temperatures are most suited for emulsions according to the present invention. Preferably, vegetable oils are used. Olive oil is a most preferred oil in the emulsion, for its health aspects and general desirability as a savory sauce ingredient. The edible oil makes up from about 10% by weight to about 80% by weight of the emulsion.

The emulsion contains an alginate, which has no impact upon the emulsion, but serves as a gelling agent when the emulsion is immersed in an ionic bath. A preferred alginate is an alginate salt, preferably sodium alginate, available from Kelco, used in an amount of about 2% to about 5% by weight of the emulsion, including all ranges subsumed therein, and preferably about 3% by weight of the emulsion. Alginates may be found in and isolated from various organisms, in particular from algae belonging to the order Phaeophyceae and soil bacteria such as Azotobacter vinelandii and Azotobacter crococcum and from several strains of Pseudomonas bacteria. Alginic acid is a linear hetero-polysaccharide comprising units of β-D-mannuronic acid and α-L-guluronic acid. Alginic acid may comprise homopolymeric sequences of mannuronic acid, homopolymeric sequences of guluronic acid, and mixed sequences of mannuronic acid and guluronic acid units. Salts of alginic acid used in the method of the present invention may include alkali metal salts, for example sodium and potassium salts, and ammonium and alkanolamine salts. Alkali metal salts are of particular interest. Preferred are water-swellable, preferably water soluble, salts of alginic acids. Most preferably they are provided as solutions, substantially without precipitates therein. The term “alginates” as used herein includes salts of alginic acid, irrespective of the relative proportion of mannuronic and guluronic units, and is intended to include glycolated or alkoxylated derivatives, especially those derivatised with propylene glycol. Guluronic acid-rich alginic acid and guluronic acid-rich alginates are of particular interest.

The gellation by the alginate is activated by immersing the emulsion in an ionic solution. Due to it being consistent with a dairy application, a preferred ionic solution contains calcium chloride in water at about 5% by weight.

After several minutes of holding the emulsion in the ionic bath, the entire emulsion becomes gelled. The texture is dependent on the length of time the olive oil emulsion is in the bath. Preferably the particulates resulting from the method of the present invention are solid.

The shape of the resulting gelled material may be affected by how the emulsion is immersed in the ionic bath. For example, the emulsion can be poured into the ionic solution to form balls or strands. The gelled material can be formed to take the shape of grated cheese or formed into large blocks and grated to form particulates of any shape or size, such as balls or strands or other shapes. The preferred shape of the gelled material has the appearance of grated cheese, e.g. 2-4 mm in thickness or in smallest dimension.

The particulates can be heat treated without melting, unlike real cheese and unlike compositions containing high amounts of cheese. Intact particles remain not completely melted when the sauce in which they are incorporated is heated, so that they are still recognizable as particulates.

The particulates are incorporated in shelf stable pasteurized sauces in amounts up to about 30% by weight imitation particulates. The sauce may optionally, but preferrably, contain up to about 30% real cheese in addition to the imitation particulates.

There is no limitation with respect to the type of sauce that may be used in this invention other than that the sauce is suitable to heat and serve with pasta as the primary use. A preferred type of sauce that may be used in this invention, as this is where the application of this invention is most advantageous, is in acidified sauces. Acidified sauces tend to be relatively acidic, with a pH of about 3.5 to about 4.5, more preferably about 3.8 to about 4.2. Most preferred acidified sauces are tomato-based sauces. For shelf stability, acidified sauces are pasteurized at about 195° F. (about 90° C.) for about 2 to about 5 minutes, depending on particulates content. For higher particulates content, longer pasteurization times are used. Therefore, heat resistance of the particulates to at least about these temperatures is required, as well as stability at the sauce pH of about 3.8 to about 4.2. Sauces sold under the ERTOLLI, RAGU and KNORR brands are especially preferred.

The sauce (before being combined with pasta) is typically heated (i.e., cooked) to a temperature from about 70° C. to about 125° C., and preferably, from about 75° C. to about 105° C., and most preferably, from about 90° C. to about 100° C. ( about 195° F. to about 212° F.), including all ranges subsumed therein.

In the following, several examples of application of the inventive system and method are described. The following is by way of example, not by way of limitation, of the principles of the invention to illustrate the best mode of carrying out the invention.

### EXAMPLE

“Faux Mozzarella Balls” were prepared by spherification of olive oil as part of the following composition:

Composition

87.4 g water

3.3 g sodium alginate

0.35 g polysorbate 60 (P-60, emulsifier)

18 g olive oil

Process for Emulsification

1. Water, sodium alginate and P-60 were combined in a food processor until fully mixed.

2. Olive oil was added slowly to the mix of step 1 with continued mixing.

3. Mixing was continuted until the a milky color/opaque emulsion was formed.

Process for Solidification

1. A 5% by weight calcium chloride solution was prepared.

2. The olive oil mix from the emulsification process was poured into the calcium chloride bath. The olive oil mix was held in the bath for about 4 to about 7 minutes to create an initial outer “skin” to seal in the liquid core, thereby generating particulates that were firm to the touch.

3. Spherical particulates of olive oil were removed from the calcium chloride bath, rinsed with water, and held for subsequent incorporation in a sauce.

A tomato-based sauce was made by mixing the following ingredients in a mixer (such as a liquefier or kitchen blender) and heating the resulting mixtures to about 88° C. (about 190° F.) to about 200° F. to produce heated sauces.

TABLE 1
Sauce Composition

| Ingredient | Percent by Weight* |
|---|---|
| Water | BAL** |
| Tomato Paste | 57.00 |
| Cheese | 3.50 |
| Starch | 1.25 |
| Preservatives | 1.15 |
| Spices | 0.50 |

*based on total weight of sauce component
**BAL means balance to 100.00%

Physical properties of the cheese particulates were determined using Texture Analyzer XT2i plus equipment, distributed by Texture Technologies, U.S.A., according to the procedure recommended by the manufacturer. The results were as follows (reflected as value/standard deviation based on 10 samples):

Hardness 7971/1060 Grams Force

The hardness value is the peak force of the first compression of the product. The hardness need not occur at the point of deepest compression, although it typically does for most products.

Springiness 0.278/0.062

Springiness is how well a product physically springs back after it has been deformed during the first compression.

Cohesiveness 0.188/0.022

Cohesiveness is how well the product withstands a second deformation relative to how it behaved under the first deformation. It is measured as the area of work during the second compression divided by the area of work during the first compression.

Resilience 0.106/0.013

Resilience is how well a product “fights to regain its original position”. You can think of it as instant springiness, since resilience is measured on the withdrawal of the first penetration, before the waiting period is started.

The olive oil particulates were combined with the tomato-based sauce. The particulates were added in amounts of from about 5% to about 20% by weight of the sauce. The sauce was heated, and the olive oil particulates remained intact having the appearance and texture of cheese particulates in the sauce.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

We claim:

1. A method for producing intact particles creating the appearance of cheese particulates in a shelf-stable pasteurized sauce, comprising:
(a) preparing an oil-in-water emulsion comprising a water phase, an oil phase, and an emulsifier; further comprising adding about 2% to about 5% by weight sodium alginate to the water phase of said emulsion;
(b) placing said emulsion in an ionic solution;
thereby producing intact solid particles; wherein said particles have the appearance of cheese and are heat and pH stable so that they maintain said cheese appearance even after pasteurization in said sauce.

2. The method according to claim 1, wherein said ionic solution is calcium chloride solution at about 5% by weight.

3. The method according to claim 1, wherein said emulsification process further comprises incorporation of air into the emulsion.

4. The method according to claim 1, wherein said oil phase in said emulsion comprises olive oil.

5. The method according to claim 1, wherein said intact solid particles are any shape or size.

6. The method according to claim 1, wherein said intact solid particles have a texture of cheese.

7. The method according to claim 1, wherein said cheese particulates have the appearance of grated or shredded cheese of about 2 to about 4 mm in thickness.

8. The method according to claim 1, wherein said sauce is tomato pasta sauce.

9. The method according to claim 8, wherein said sauce is non-retorted.

10. The method according to claim 8, wherein said sauce is hot filled.

11. The method according to claim 1, wherein said cheese particulates have a heat resistance to at least about 90° C.

12. The method according to claim 8, wherein said sauce is pasta sauce having a pH of about 3.5 to about 4.5.

13. The method according to claim 1, wherein said emulsion comprises about 3% of said sodium alginate on the basis of weight of the emulsion.

14. The method according to claim 1, wherein said intact solid particles have the physical properties as measured by the Texture Analyzer XT2i plus:
Firmness about 7971 grams force
Springiness about 0.278
Cohesiveness about 0.188
Chewiness about 412
Resilience about 0.106
